(19) United States
(12) Patent Application Publication
(10) Pub. No.: US 2024/0078402 A1
(43) Pub. Date: Mar. 7, 2024

(54) QR Tag

(71) Applicant: Human Interaction, Inc., Wilmington, DE (US)

(72) Inventors: Valentine Bosenko, Tel Aviv-Yafo (IL); Nikita Bukoros, Kyiv (UA)

(21) Appl. No.: 17/930,098

(22) Filed: Sep. 7, 2022

(51) Int. Cl. G06K 19/06; G06K 19/07; G06K 19/077

(52) U.S. Cl. CPC G06K 19/06009; G06K 19/0702; G06K 19/0723; G06K 19/07705

(57) ABSTRACT

A quick response tag is provided. The tag includes a body having a front side and a back side, the front side having a laser engraved QR code and the back side having a laser engraved QR code. The tag further includes a first leg and a second leg extending from the top of the body.

### FIELD OF INVENTION

Numerous devices have been designed to identify and provide information about various objects by being physically attached to them. The before-mentioned devices bear the designation of name tags, ID tags, information clips, and the similar. The invention described is named QR Tag and essentially is a self-attaching identification tag, marked with a two-dimensional machine-readable code linking to the identification information and/or RFID (Radio Frequency Identification)/NFC (Near Field Communication) technology. It can be attached to personal belongings like bags, purses, keys, clothes, and the similar, as well as to pet collars; and is effectively used to identify people, pets, and physical objects.

### DESCRIPTION OF THE RELATED ART

Existing identification tags are usually small objects bearing the possibility of attachment to the subject of identification with necessary information available to be read. The tags may be classified according to the ways of attachment, the methods of providing identification information, and the ability to change the information when necessary.

Generally, the tag is attached to the subject of identification by an additional object, which is not part of the tag itself. Examples of this way of attachment include key rings, various chains, threads or rubber bands, clips etc. The disadvantage of this attachment method is based on the properties of the additional fixing part, and if it breaks due to regular wear and tear, the identification tag loses its primary value of association with the subject. This problem may be addressed by a firmer means of attachment, including but not limited to the use of pins and glue, but the mentioned means are invasive, may cause damage to the identification subject, and often make it difficult or nearly impossible to remove the tag from the subject.

The identification information on the tag is generally presented either in a human or machine-readable format. The human-readable format often exists in the form of text, which may be handwritten, printed, painted or engraved on the surface of the tag itself or some of its detachable parts. All the above methods have the physical limitation of the surface area which can be used for putting information upon. Moreover, writing, printing or painting present the problem of the durability of data put on a tag, which is often exposed to unfavourable external conditions; additionally, the information presented in such ways may be ineligible to be effectively read either inherently (for example, due to confusing handwriting or the language used) or in the process of a tag being in use under influence of tear, weather conditions, ultraviolet light and similar factors. Engraving might address the mentioned issues, but it generally can be conducted using specific tools not available to households, making the use of such tags infeasible for the general public. Machine-readable information storage allows for quick and efficient data transfer, while disadvantageously requiring specific appliances in the process and therefore becoming inefficient or inaccessible for the general public as well.

All the mentioned methods of putting the relevant information about the subject of identification of the tag suffer to a certain extent from the problem arising in the event of the necessity to change the information and/or the subject. The severity of this problem lies in a wide range between the replacement of the indivisible tag (if the information is engraved or otherwise became an integral part of the tag) or at least it's replaceable part (for instance, the handwritten card used in luggage identification) and rewriting the machine-readable information using special equipment.

The proposed QR Tag concept addresses the mentioned issues of the ease of attachment to the identification subject reached via undetachable integral part of the tag, information access achieved with laser engraved QR code readable by all modern smartphones, and information changeability by using a web and mobile-based platform for easy data storage and modification with unique editable description assigned to each unique QR code placed on each QR tag item.

### SUMMARY OF THE INVENTION

There exists a clear necessity for the invention to solve the before-mentioned problems inherent to the existing tag designs. The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a one-piece solid plastic tag consisting of a rectangular “body” with rounded edges and two “legs” constituting the attachment mechanism, produced by casting in the press form, an attachment mechanism of two overlapping “legs” resembling the key chain ring, one or two QR codes engraved by the laser on both sides of the “body”, an enhancement of the QR tag with human-readable unique identifiers, RFID (Radio Frequency Identification) and NFC (Near Field Communication) technology, a GPS tracker, diode lights, and a battery to power the electric components.

### BRIEF DESCRIPTION OF THE DRAWINGS

The accompanying drawings are not intended to be drawn to scale. In the drawings, each identical or nearly identical component that is illustrated in various figures is represented by an alike numeral. For purposes of clarity, not every component may be labelled in every drawing. In the drawings:

FIG. 1 illustrates the three-dimensional side view of the QR tag, featuring the “body” with an engraved QR code and two “legs” forming an attachment mechanism.

FIG. 2 illustrates the functioning of the QR tag attachment mechanism in its “open” position.

FIG. 3 illustrates the side views of the QR tag from the top short edge and the side long edge.

### DETAILED DESCRIPTION OF THE INVENTION

This invention is not limited in its application to the details of construction and the arrangement of components outlined in the following description or illustrated in the drawings.

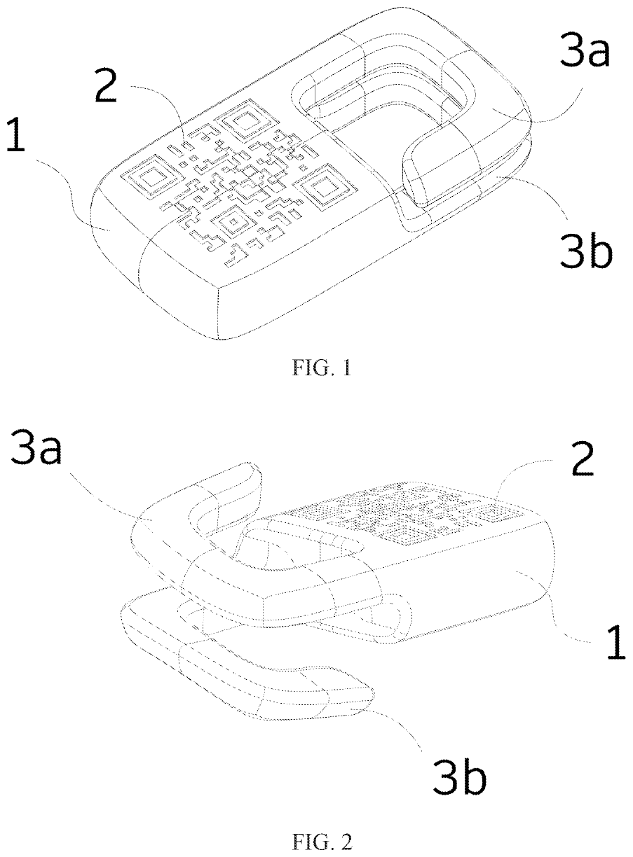

Referring to FIG. 1, a side view of the QR tag is illustrated in accordance with the design of the invention. According to the illustrated design, the QR tag embodies a one-piece solid plastic tag consisting of a rectangular “body” with rounded edges produced by casting in the press form (1) with the unique QR code (2) engraved by the laser on both sides of the “body” (only one side is visible on the drawing), and two “legs” (3a) and (3b) constituting the attachment mechanism.

Referring to FIG. 2, a side view of the QR tag is illustrated to depict the functionality of the attachment mechanism, consisting of two “legs” (3a) and (3b). The mentioned “legs” in the open position allow the QR tag attached to the subject of identification. Without the application of the external force, the “legs” return to their closed position automatically.

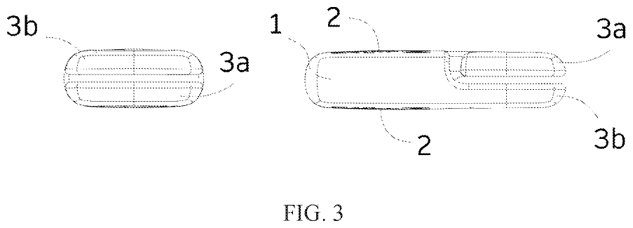

Referring to FIG. 3, a side view and a top view of the QR tag are illustrated to effectively depict the “legs” (3a) and (3b) in the closed position, as well as the presence of two identical laser engraved two-dimensional QR codes labelled (2) on both wide sides of the QR tag, making the codes readable independent of the tag's positioning.

What is claimed is:

1. A quick response (QR) tag, comprising:
a body having a front side, a back side, the front side having a laser engraved QR code and the back side having a laser engraved QR code; and
a first leg and a second leg extending from the top of the body, the first leg extending from the front left side of the body, the second leg extending from the from the back right side of the body.

2. The QR tag of claim 1, wherein the first leg and the second leg are hook shaped and configured to return to the hook shaped closed position when no external force is applied.

3. The QR tag of claim 2, further comprising a global position system tracking module.

4. The QR tag of claim 2, further comprising a diode light.

5. The QR tag of claim 2, further comprising a radio frequency identification/near field communication module.

6. The QR tag of claim 2, further comprising an internal battery configured to supply power to the device.

7. A quick response (QR) tag, comprising:
a body having a front side, a back side, the front side having a laser engraved QR code and the back side having a human-readable unique text identifier; and
a first leg and a second leg extending from the top of the body, the first leg extending from the front left side of the body, the second leg extending from the from the back right side of the body.

8. The QR tag of claim 7, wherein the first leg and the second leg are hook shaped and configured to return to the hook shaped closed position when no external force is applied.

9. The QR tag of claim 8, further comprising a global position system tracking module.

10. The QR tag of claim 8, further comprising a diode light.

11. The QR tag of claim 8, further comprising a radio frequency identification/near field communication module.

12. The QR tag of claim 8, further comprising an internal battery configured to supply power to the device.
